(19) United States
(12) Patent Application Publication
(10) Pub. No.: US 2001/0053727 A1
(43) Pub. Date: Dec. 20, 2001

(54) Belt transmission system

(76) Inventors: Eijiro Nakashima, Hyogo (JP); Hiroyuki Sakanaka, Hyogo (JP); Hiroyuki Sato, Hyogo (JP)

Correspondence Address: NIXON PEABODY, LLP, 8180 GREENSBORO DRIVE, SUITE 800, MCLEAN, VA, 22102, US

(21) Appl. No.: 09/877,070

(22) Filed: Jun. 11, 2001

(30) Foreign Application Priority Data
Jun. 13, 2000 (JP) 2000-176380

(51) Int. Cl. F16G 1/21

(52) U.S. Cl. 474/242

(57) ABSTRACT

In a belt transmission system including a combination of a V-belt for heavy load transmission and V-pulleys as variable speed pulleys, the surface roughness of a pulley groove of each V-pulley is set within the range from 0.5 to 3.0 μm to reduce energy generated when the V-belt and the V-pulleys are interfered with each other thereby reducing production of running noise during belt running.

### BACKGROUND OF THE INVENTION

(a) Field of the Invention

This invention relates to a belt transmission system using a V-belt for heavy load transmission, and particularly relates to techniques for preventing noise production therefrom.

(b) Description of the Prior Art

As a V-belt for heavy load transmission of such kind, there is conventionally known one that includes: a pair of tension bands each having top and bottom faces formed with concavities and convexities; and a large number of blocks each having both side faces each formed with a fit section with which the concavity and convexity of the corresponding tension band are fitted. The large number of blocks are aligned lengthwise of the belt and fixedly engaged with the pair of tension bands with the tension bands respectively press-fitted into the fit sections of each block.

However, in a belt transmission system formed by combining such a V-belt for heavy load transmission having a large number of blocks with V-pulleys, there arises a problem in that running noise during belt running is larger as compared with a normal V-belt. Such running noise during belt running is classified into two types, i.e., impact sound produced when the block of the belt contacts a groove surface of the V-pulley and sticking sound produced when the belt block is separated from the groove surface of the V-pulley. In order to reduce these types of sound, it is necessary to reduce energy generated when the belt block and the V-pulley are interfered with each other.

The inventor has conceived that the energy generated by interference of the belt block with the V-pulley can be reduced by lowering the coefficient of friction between the belt block and the V-pulley. For this purpose, an approach of changing the coefficient of friction on the belt block can be considered. In this case, however, the coefficient of friction of the block must be held within a predetermined range in terms of power transmission property. Therefore, such an approach cannot be an effective solution.

An object of the present invention is to provide a belt transmission system which can reduce noise by lowering energy generated when a pulley and a V-belt for heavy load transmission are interfered with each other through improvement of a groove surface of the pulley.

### SUMMARY OF THE INVENTION

To attain the above object, the inventor directs attention to that a V-belt for heavy load transmission has a characteristic of varying the coefficient of friction of its block depending upon the surface roughness of the associated member, and intends to reduce running noise during belt running by setting the surface roughness of the groove of the V-pulley as the associated member within a specific range to hold the coefficient of friction between the block and the pulley groove surface at a proper level.

Specifically, the present invention is directed to a belt transmission system that includes a combination of: a V-belt for heavy load transmission formed by fixedly engaging a large number of blocks with a pair of tension bands in fitted relation with each other; and two or more V-pulleys about which the belt is entrained, and that transmits power by contact of a working flank of the V-belt with a groove surface of each of the V-pulleys. In this belt transmission system, the surface roughness Ra of the groove surface of at least one of the V-pulleys is set at 0.5 to 3.0 μm.

With this structure, the groove surface of said at least one pulley has a relatively large surface roughness Ra ranging from 0.5 to 3.0 μm. Therefore, during contact of the V-pulley with the V-belt which causes production of running noise, the coefficient of friction between the block of the V-belt and the contacting groove surface of the V-pulley is decreased thereby reducing energy generated when the belt block is interfered with the V-pulley. This reduces running noise during belt running.

The reason why the surface roughness Ra of the groove of the variable speed pulley is set at 0.5 to 3.0 μm is as follows. If Ra is less than 0.5 μm, the coefficient of friction between the V-pulley and the V-belt abruptly increases. On the contrary, if Ra is over 3.0 μm, the specific wear rate of the belt block abruptly increases and therefore the V-belt will have a problem in its durability.

Said at least one V-pulley can be a variable speed pulley changeable in pitch diameter with which the belt is entrained about the V-pulley. With this structure, the present invention can be applied to variable-speed belt transmission systems changeable in pulley pitch diameter with which the belt is entrained about the variable speed pulley. In this manner, energy generated when the V-belt and the V-pulley of the variable-speed belt transmission system are interfered with each other can be reduced thereby providing noise reduction.

Further, said at least one V-pulley may be a constant speed pulley unchangeable in pitch diameter with which the belt is entrained about the V-pulley. With this structure, the present invention can be applied to belt transmission systems having a constant pulley pitch diameter which leads to a constant speed ratio. In this manner, energy generated when the V-belt and the V-pulley of the constant-speed belt transmission system are interfered with each other can be reduced thereby providing noise reduction.

Furthermore, a portion of the block of the V-belt contacting with the groove surface of said at least one V-pulley can be a resin-made portion. With this structure, since the block contacts at its resin-made portion with the groove surface of the pulley, there can be concretely implemented a block changing its characteristic depending upon the surface roughness of the pulley.

### BRIEF DESCRIPTION OF THE DRAWING

FIG. 1 illustrates a high speed mode of a belt transmission system according to an embodiment of the present invention.

FIG. 2 illustrates a mid-speed mode of the belt transmission system.

FIG. 3 illustrates a low-speed mode of the belt transmission system.

FIG. 4 illustrates the surface roughness of a groove of a variable speed pulley.

FIG. 5 is a perspective view of a V-belt for heavy load transmission.

FIG. 6 is a schematic view showing a noise tester.

FIG. 7 is a graph showing the relationship between the revolving speed of a drive shaft and the noise level when the surface roughness of the V-pulley changes.

FIG. 8 is a graph showing the relationship between the average noise level and the surface roughness of the V-pulley.

FIG. 9 is a graph showing the relationship between the coefficient of friction and the surface roughness of the V-pulley.

FIG. 10 is a graph showing the relationship between the specific wear rate of the V-belt and the surface roughness of the V-pulley.

### DESCRIPTION OF THE PREFERRED EMBODIMENTS

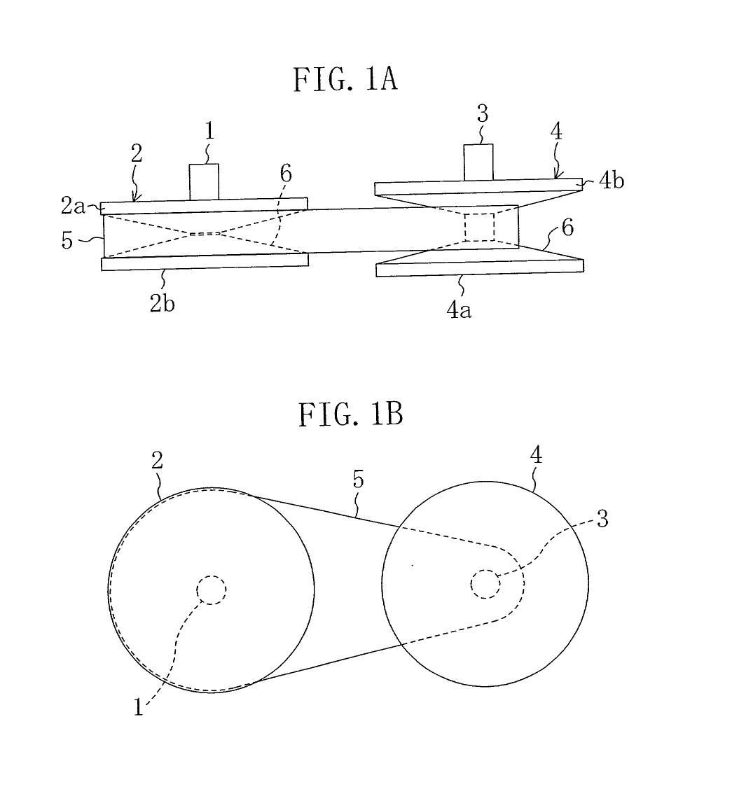

Hereinafter, an embodiment of the present invention will be described with reference to the drawings. FIGS. 1 to 3 show a belt transmission system according to the embodiment of the present invention. In the figure, a reference numeral 1 denotes a drive shaft and a reference numeral 3 denotes a driven shaft. Both of these shafts 1 and 3 are disposed in parallel with each other.

A drive pulley 2 formed of a variable speed pulley is disposed on the drive shaft 1. This drive pulley 2 includes a flanged fixed sheave 2a fixed for unitary rotation and against sliding movement on the drive shaft 1 and a flanged movable sheave 2b supported for sliding movement and unitary rotation on the drive shaft 1 so as to be opposed to the fixed sheave 2a. A pulley groove 6 for receiving a belt is formed between both the sheaves 2a and 2b.

The drive shaft 3 is provided with a driven pulley 4 formed of a variable speed pulley having the same diameter as that of the drive pulley 2. The driven pulley 4 has a construction similar to the drive pulley 2. Specifically, the driven pulley 4 includes a flanged fixed sheave 4a fixed for unitary rotation and against sliding movement on the driven shaft 3, and a flanged movable sheave 4b for sliding movement and unitary rotation on the driven shaft 3 so as to be opposed to the fixed sheave 4a in inverted disposition from that between the movable sheave 2b and the fixed sheave 2a of the drive pulley 2. A pulley groove 6 for receiving a belt is formed between both the sheaves 4a and 4b.

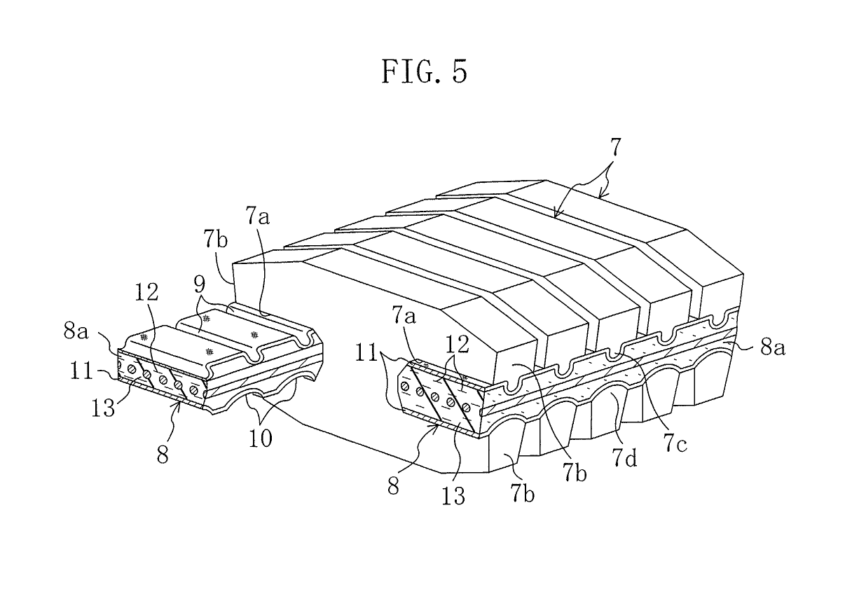

A V-belt 5 for heavy load transmission is entrained over both the pulley grooves 6, 6 of the drive and driven pulleys 2 and 4. As shown in FIG. 5, the V-belt 5 includes a pair of endless tension bands 8, 8 arranged widthwise of the belt and a large number of blocks 7, 7, . . . fixedly engaged with the tension bands 8, 8 consecutively in a lengthwise direction of the belt.

Each of the tension bands 8 is formed so that a high-strength, high-elasticity cord (tension member) made of aramid fibers (braids) or the like is spirally disposed and buried inside of a shape retention rubber layer 13 made of hard rubber. The top face of each tension band 8 has groove-shaped upper concavities 9, 9, . . . formed at regular pitches to extend widthwise of the belt. The bottom face of each tension band 8 has lower concavities 10, 10, . . . formed at regular pitches to extend widthwise of the belt in correspondence with the upper concavities 9,9, . . . . Further, fabrics 11, 11 are adhered to the top and bottom faces of the tension band 8, respectively, for the purposes of preventing creation of cracks or improving wear resistance.

As hard rubber forming the shape retention rubber layer 13, use is made of hard rubber excellent in heat resistance and difficult in permanent deformation which is fabricated by, for example, hydrogenated NBR (H-NBR) rubber reinforced with zinc methacrylate and into which organic short fibers 12, 12, are entirely mixed for further reinforcement. It should be noted that the hard rubber needs to have a hardness of 75 degrees or more when measured by a JIS-C hardness tester.

Each block 7 has cut-away groove-shaped fit sections 7a and 7a, formed one at each side of the block in a belt widthwise direction, for fitting the tension bands 8, 8 therein to allow disengagement from the belt widthwise direction, respectively. Portions of the side faces of the block 7 other than the fit sections 7a, 7a are formed into contact portions 7b, 7b for contact with the pulley grooves 6, 6 of the drive and driven pulleys 2 and 4. The angle formed by both the lateral contact portions 7b, 7b of the block 7 is set to be equal to the angle of the pulley groove 6 of each pulley 2, 4. The blocks 7, 7, . . . are fixed to the tension bands 8, 8 consecutively in the belt lengthwise direction by press-fitting the tension bands 8, 8 into the fit sections 7a, 7a, respectively.

More specifically, the upper surface of each fit section 7a of the block 7 is formed with an upper convexity 7c made of a rib as an upper mating part which mates with one of the upper concavities 9 in the top face of the tension band 8, while the bottom surface of each fit section 7a is formed with a lower convexity 7d made of a rib as a lower mating part which mates with one of the lower concavities 10 in the bottom face of the tension band 8. These pair of upper and lower convexities 7c and 7d are disposed in parallel. The blocks 7, 7, . . . are fixedly engaged with a press-fit onto the tension bands 8, 8 in the belt lengthwise direction by mating the upper and lower convexities 7c and 7d of each block 7 with the upper and lower concavities 9 and 10 of the tension band 8. In this engagement relation, the outside surface of each tension band 8 and the contact portion 7b of the side face of each block 7 are brought into contact with the pulley grooves 6 of the pulleys 2 and 4. Power transmission can be effected by the mating of the upper and lower convexities 7c and 7d of the block 7 with the upper and lower concavities 9 and 10 of each tension band 8.

Each block 7 is made of hard resin material and contains a reinforcement (not shown) made of light-weight aluminum alloy buried therein so as to be placed substantially in the middle of the block 7. The reinforcement is not exposed at least from the upper and lower convexities 7c and 7d (portions mating with the tension band 8) or from the contact portions 7b, 7b in both the side faces because it is buried in hard resin (i.e., these portions are made of hard resin) . However, the reinforcement may be exposed from the other portions of the block 7 surface.

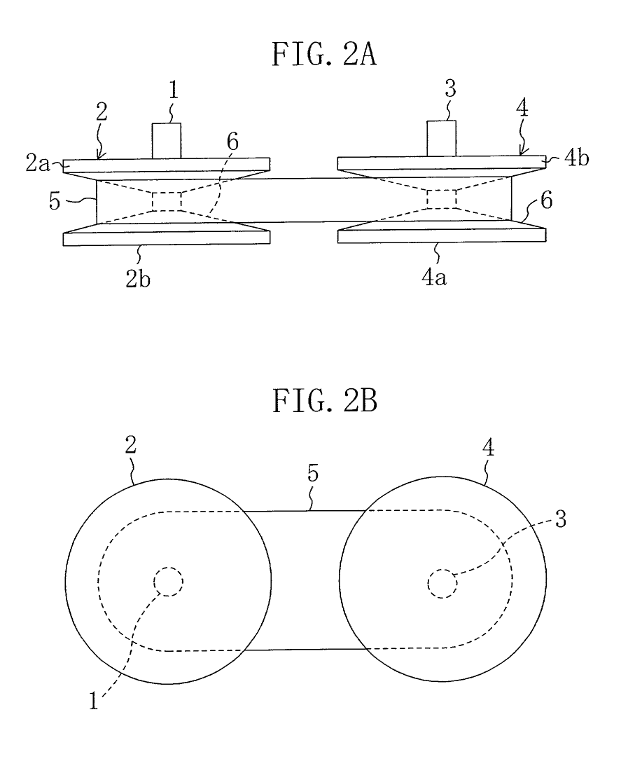

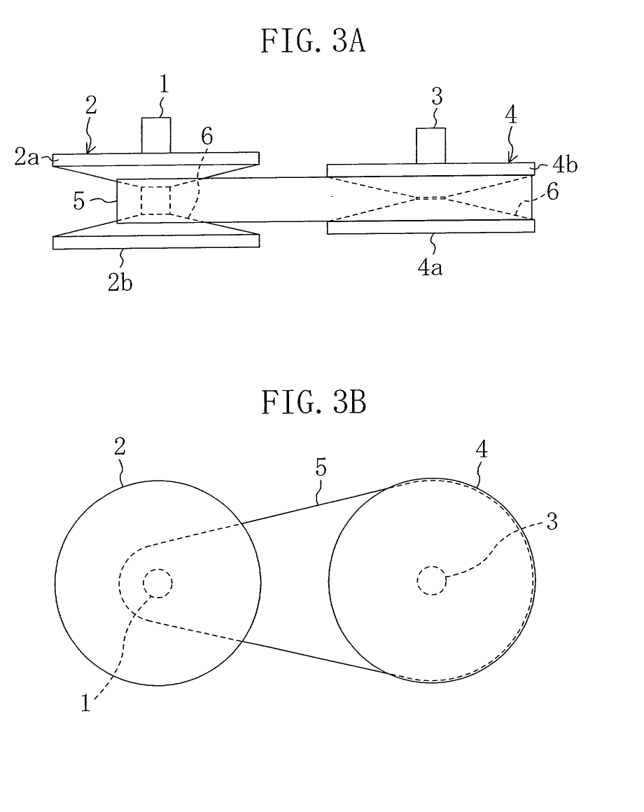

The belt transmission system is arranged to change the pitch diameter of each pulley 2, 4, with which the belt 5 is entrained, by moving the movable sheaves 2b and 4b of both the pulleys 2 and 4 close to or away from the corresponding fixed sheaves 2a and 4a. More specifically, for the transition to a high speed mode as shown in FIG. 1, the movable sheave 2b of the drive pulley 2 is moved close to the fixed sheave 2a and the movable sheave 4b of the driven pulley 4 is moved away from the fixed sheave 4a. Thus, the pitch diameter of the drive pulley 2 becomes larger than that of the driven pulley 4 so that the belt transmission system enters in a high speed mode where the revolution of the drive shaft 1 is transmitted to the driven shaft 3 at an increased rate. On the contrary, for the transition to a low speed mode as shown in FIG. 3, the movable sheave 2b of the drive pulley 2 is moved away from the fixed sheave 2a and the movable sheave 4b of the driven pulley 4 is moved close to the fixed sheave 4a. Thus, the pitch diameter of the drive pulley 2 becomes smaller than that of the driven pulley 4 so that the belt transmission system enters in a low speed mode where the revolution of the drive shaft 1 is transmitted to the driven shaft 3 at a reduced speed. Further, in a mid-speed mode as shown in FIG. 2, the belt transmission system is in an intermediate condition between the high speed and low speed modes and in this mode, the drive and driven pulleys 2 and 4 have substantially equal pitch diameters.

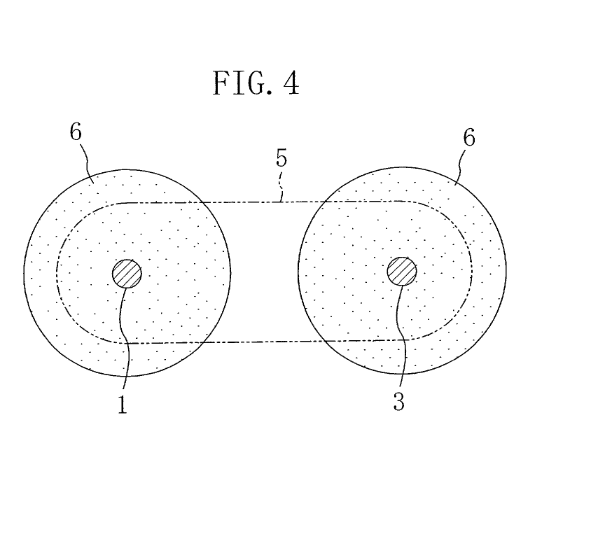

Furthermore, in the belt transmission system of this embodiment, as shown in FIG. 4, the surface roughness Ra of the pulley groove 6 of each variable speed pulley 2, 4 which comes into contact with the belt 5 is set at a uniform value, specifically, within the range from 0.5 to 3.0 μm.

As described above, in this embodiment, the surface roughness Ra of the pulley groove 6 of the V-pulley 2, 4 is set within the range from 0.5 to 3.0 μm regardless of variable-speed driving conditions of the belt transmission system, in order to reduce energy generated during contact of the V-belt 5 for heavy load transmission with the V-pulleys 2 and 4. Therefore, the coefficient of friction of the block 7 of the belt 5 is kept approximately constant, and concurrently the coefficient of friction between the block 7 and the pulley groove 6 of each of the pulleys 2 and 4 can be decreased. Accordingly, energy generated when the belt 5 is interfered with the V-pulleys 2 and 4, which causes production of running noise during belt running, can be reduced thereby providing reduced running noise.

This embodiment employs a belt transmission system which includes variable speed pulleys each formed of a fixed sheave and a movable sheave. However, it goes without saying that the present invention can be applied to a belt transmission system which includes V-pulleys each formed of a constant speed pulley of constant pitch diameter including a pair of fixed sheaves only.

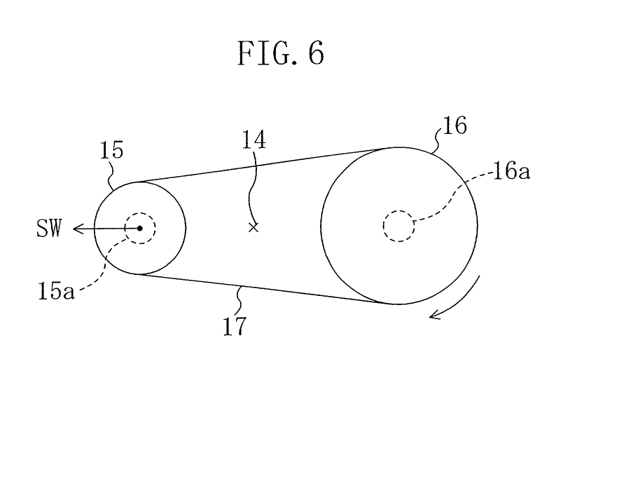

Next, a concrete example of the present invention will be described. First, consideration will be made about a noise level by changing the surface roughness of the groove of the V-pulley. FIG. 6 schematically shows a noise tester used in this example. In the noise tester as shown in FIG. 6, a drive pulley 15 with a pitch diameter of 65.32 mm disposed on a drive shaft 15a and a driven pulley 16 with a pitch diameter of 130.64 mm disposed on a driven shaft 16a are spaced at a predetermined center distance. A V-belt 17 for heavy load transmission which is the same as described in the above embodiment (see FIG. 5) is entrained over both the pulleys 15 and 16. Both the pulleys 15 and 16 were rotated with a set load SW (=3000 N) applied to the drive pulley 15 in a direction of arrow in FIG. 6. Further, a sound pressure level measuring means formed of a microphone was set at a measuring point 14 located 100 mm apart rightward (toward the driven shaft 16a) from the center of the drive shaft 15a.

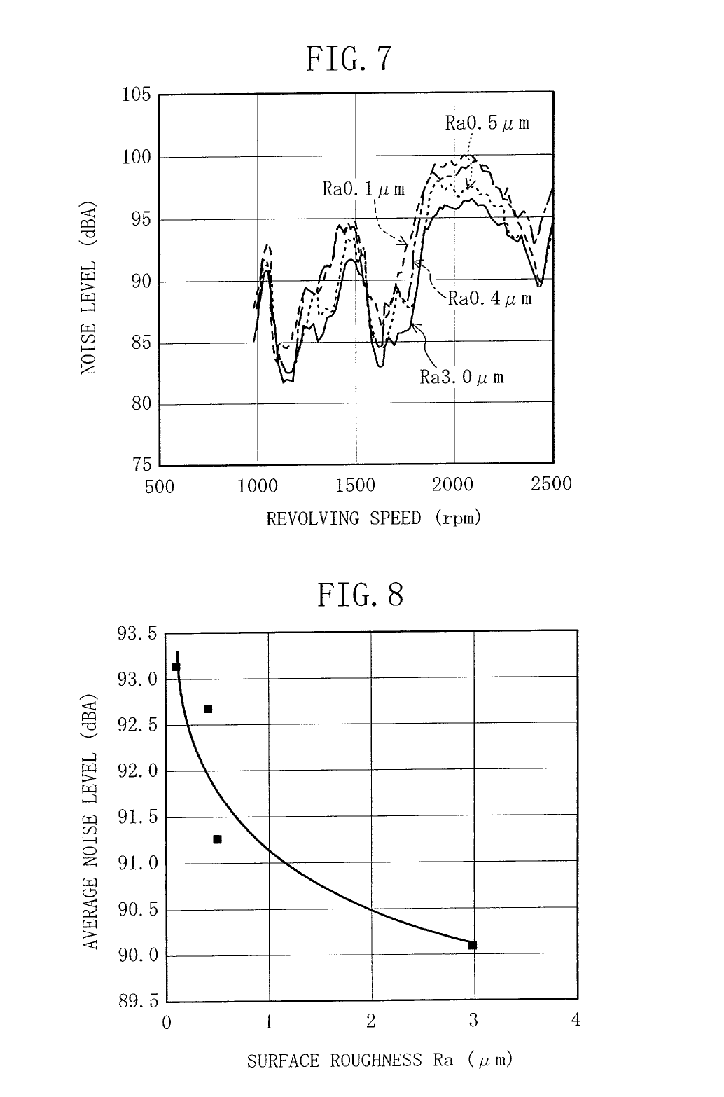

The surface roughness Ra of the groove of each pulley 15, 16 was set to four different conditions, i.e., 0.1 μm, 0.4 μm, 0.5 μm and 3.0 μm. Measurement was made, with the sound pressure level measuring means at the measuring point 14, of the A-weighted sound pressure level (unit: dBA) of noise produced during operation of the belt transmission system when the revolving speed (rpm) of the drive pulley 15 changes under the above four conditions. The measurement results are shown in FIGS. 7 and 8.

FIG. 7 shows the relationship between the surface roughness of the groove of the drive pulley 15 and the noise level (A-weighted sound pressure level) when the drive pulley 15 is changed in rpm. As can be seen from the measurement results, the noise level becomes lower as the surface roughness Ra of the groove of each V-pulley 15, 16 is increased from 0.1 μm in turn to 0.4 μm, 0.5 μm and 3.0 μm, independent of the revolving speed (rpm) of the drive pulley 15.

FIG. 8 shows the relationship between the surface roughness of the groove of each V-pulley 15, 16 and the average noise level (unit: dBA). As can be seen from FIG. 8, the average noise level becomes lower as the surface roughness of the pulley groove is increased. As also can be seen from the figure, the average noise level is abruptly increased to more than 92.5 dBA if the surface roughness Ra is less than 0.5 μm, while the average noise level ranges from 90 to 91.5 dBA thereby reducing noise if Ra is 0.5 μm or more.

The foregoing measurement results demonstrate that if the surface roughness Ra of the groove of each V-pulley 15, 16 is set at 0.5 μm or more, running noise during belt running can be reduced effectively.

On the other hand, evaluation was made of the coefficient of friction between the V-pulley and the V-belt for heavy load transmission and the specific wear rate of the V-belt when the surface roughness of the groove of the V-pulley in the belt transmission system is changed.

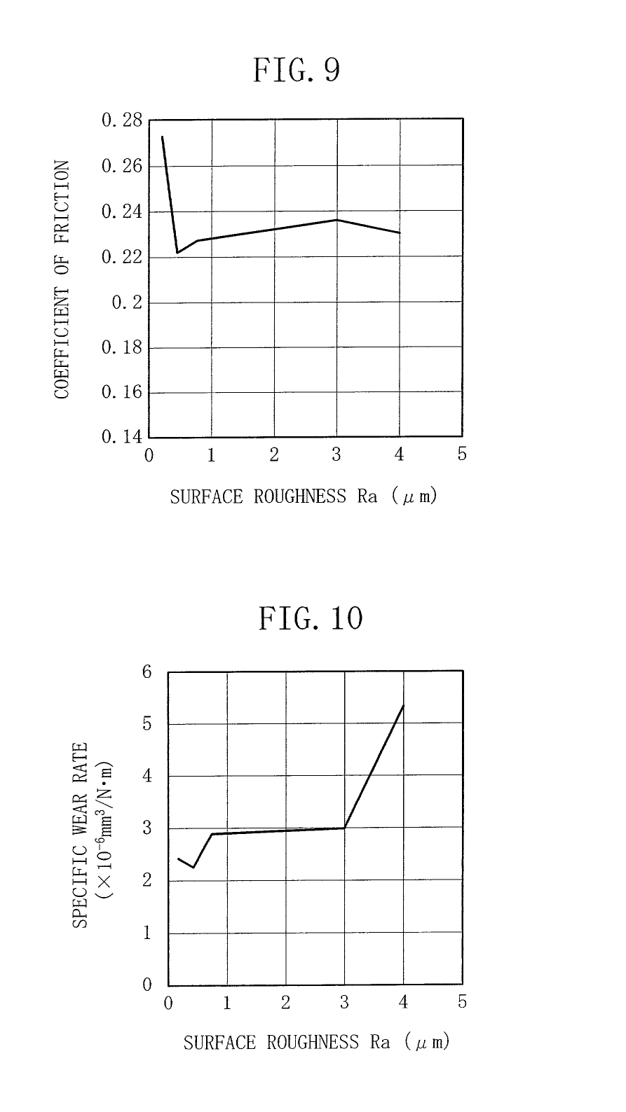

FIG. 9 shows the relationship between the surface roughness of the pulley groove of the V-pulley and the coefficient of friction. In the evaluation test, a V-belt was entrained over the drive and driven pulleys, the drive pulley was rotated with the driven pulley locked against rotation, and in this conditions the coefficient of friction was calculated by a predetermined formula using the contact angle of the V-belt with the drive pulley or the like.

As can be seen from FIG. 9, the coefficient of friction becomes a large value of 0.24 or more if the surface roughness Ra of the pulley groove is less than 0.5 μm, while the coefficient of friction becomes a small value ranging from 0.22 to 0.24 if the surface roughness Ra is 0.5 μm or more.

FIG. 10 shows the relationship between the surface roughness of the pulley groove of the V-pulley and the specific wear rate (unit: mm³/ (N·m) of the belt block. As can be seen from FIG. 10, if the surface roughness Ra of the pulley groove is over 3.0 μm, the specific wear rate is abruptly increased. If the surface roughness Ra ranges from 0.5 to 3.0 μm, the specific wear rate is steady at a lower value. If the surface roughness Ra is less than 0.5 μm, the specific wear rate is further decreased to a value ranging from 2 to 3 mm³/(N·m), which is still lower as compared with the case where the surface roughness Ra ranges from 0.5 to 3.0 μm.

Therefore, if the surface roughness Ra of the pulley groove of the V-pulley is over 3.0 μm, the specific wear rate is abruptly increased, which may cause a problem in durability of the V-belt.

What is claimed is:

1. A belt transmission system that comprises a combination of: a V-belt for heavy load transmission formed by fixedly engaging a large number of blocks with a pair of tension bands in fitted relation with each other; and two or more V-pulleys about which the belt is entrained, and that transmits power by contact of a working flank of the V-belt with a groove surface of each of the V-pulleys,
wherein the surface roughness Ra of the groove surface of at least one of the V-pulleys is set at 0.5 to 3.0 μm.

2. The belt transmission system of claim 1,
wherein said at least one V-pulley is a variable speed pulley changeable in pitch diameter with which the belt is entrained about the V-pulley.

3. The belt transmission system of claim 1,
wherein said at least one V-pulley is a constant speed pulley unchangeable in pitch diameter with which the belt is entrained about the V-pulley.

4. The belt transmission system of any one of claims 1 to 3,
wherein a portion of the block of the V-belt contacting with the groove surface of said at least one V-pulley is a resin-made portion.
